(19) United States
(12) Patent Application Publication
(10) Pub. No.: US 2014/0059760 A1
(43) Pub. Date: Mar. 6, 2014

(54) INFLATABLE POOL FOR DOGS

(71) Applicant: James Leyland Hendrick, New York, NY (US)

(72) Inventor: James Leyland Hendrick, New York, NY (US)

(21) Appl. No.: 13/972,822

(22) Filed: Aug. 21, 2013

Related U.S. Application Data
(60) Provisional application No. 61/694,677, filed on Aug. 29, 2012.

(51) Int. Cl. A01K 15/02; E04H 4/00

(52) U.S. Cl. CPC A01K 15/027; E04H 4/0025
USPC 4/506

(57) ABSTRACT

A dog pool provides a convenient, easy-to-use product for dogs to swim in, or fun, exercise and therapy. The dog pool is durable, portable, easy to set up and easy to store. Because the dog pool is made of inflatable PVC tarpaulin material, it can be made larger and deeper than conventional pools and still be easy to store, set up and move. A step can be included along at least a portion of one wall on the inside of the dog pool to assist the dog in getting themselves out of the pool. A ramp can be included on the outside of the pool, adjacent to the pool wall, to assist a dog in entering, and exiting, the pool. The pool walls and floor are typically formed as in integral unit, further increasing easy of set up and use.

### CROSS-REFERENCE TO RELATED APPLICATION

This application claims the benefit of priority of U.S. provisional application No. 61/694,677, filed Aug. 29, 2012, the contents of which are herein incorporated by reference.

### BACKGROUND OF THE INVENTION

The present invention relates to dog pools and, more particularly, to an inflatable pool for dogs to swim in, for fun, exercise and therapy.

Public dog-allowed lakes, beaches or pools are not readily available to the majority of dog owners. Moreover, such lakes, beaches and pools require travel to and from the location, the travel being even more difficult with the need to provide a place for the wet dog(s) to travel back home.

Comparable consumer dog pools are too shallow and small to provide practical exercise or therapy for dogs. Moreover, comparable pools are made with thin rigid edges which are potentially harmful to dog's elbows and torsos.

As can be seen, there is a need for consumer level dog pools large enough to allow dogs to safely swim for exercise, fun and therapy.

### SUMMARY OF THE INVENTION

In one aspect of the present invention, a dog pool comprises a plurality of interconnected air chambers, typically made of polyvinylchloride (PVC) tarpaulin, forming side walls of the dog pool; a floor disposed made of the same material on one side of the plurality of interconnected air chambers and interconnecting the plurality of interconnected air chambers, such that the plurality of interconnected air chambers and the floor form a space to contain water; and a step disposed along an inside of one of the plurality of interconnected air chambers forming the side walls.

In another aspect of the present invention, a dog pool comprises a plurality of interconnected air chambers, made of PVC tarpaulin, forming side walls of the dog pool; a floor made of the same material disposed on one side of the plurality of interconnected air chambers and interconnecting the plurality of interconnected air chambers, such that the plurality of interconnected air chambers and the floor form a space to contain water; an optional step disposed along an inside of one of the plurality of interconnected air chambers forming the side walls; a plurality of rings attached to a top of the plurality of interconnected air chambers, the plurality of rings supporting a cover over the space; filtration rings disposed on an inside of the side walls, the filtration rings adapted to retain filtration nozzles; and an inflation nozzle permitting inflation and deflation of the dog pool.

These and other features, aspects and advantages of the present invention will become better understood with reference to the following drawings, description and claims.

### BRIEF DESCRIPTION OF THE DRAWINGS

FIG. 1 is a perspective view of an inflatable pool for dogs according to an exemplary embodiment of the present invention;

FIG. 2 is a top view of the inflatable pool for dogs of FIG. 1;

FIG. 3 is a cross-sectional view taken along line 3-3 of FIG. 2;

FIG. 4 is a perspective view of an inflatable pool for dogs, illustrating an alternate shape, according to an exemplary embodiment of the present invention;

FIG. 5 is a top view of the inflatable pool for dogs of FIG. 4; and

FIG. 6 is a top view of an inflatable pool for dogs, illustrating an alternate, square shape, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a dog pool that provides a convenient, easy-to-use product for dogs to swim in, both for fun and therapy. The dog pool is portable, easy to set up and easy to store. Because the dog pool is inflatable, made of sturdy PVC tarpaulin (similar to the material used to make whitewater rafts, for example), it can be made larger and deeper than conventional pools and still be easy to store, set up and move. A step can be included along at least a portion of one wall on the inside of the dog pool to assist the dog in getting themselves out of the pool. A ramp can be included on the outside of the pool, adjacent to the pool wall, to assist a dog in entering, and exiting, the pool. The pool walls and floor are typically formed as in integral unit, further increasing easy of set up and use.

The dog pool of the present invention provides a substantial water environment for people's dogs in the safety and convenience of their own back yard. The largest comparable product marketed specifically as a “dog pool” is limited to 11 inches deep by 44 inches wide by 66 inches long, whereas the dog pool of the present invention, in one embodiment thereof, has an 18 inch depth, a 60 inch width and a 108 inch length (inside water area), providing ample for room for dogs to swim and play. Moreover, comparable pools are made with thin rigid edges which are potentially harmful to dog's elbows and torsos, whereas the dog pool of the present invention provides soft and pliable walls. Inflatable pools also have the advantage of being easily deflated and rolled up for transport and compact storage.

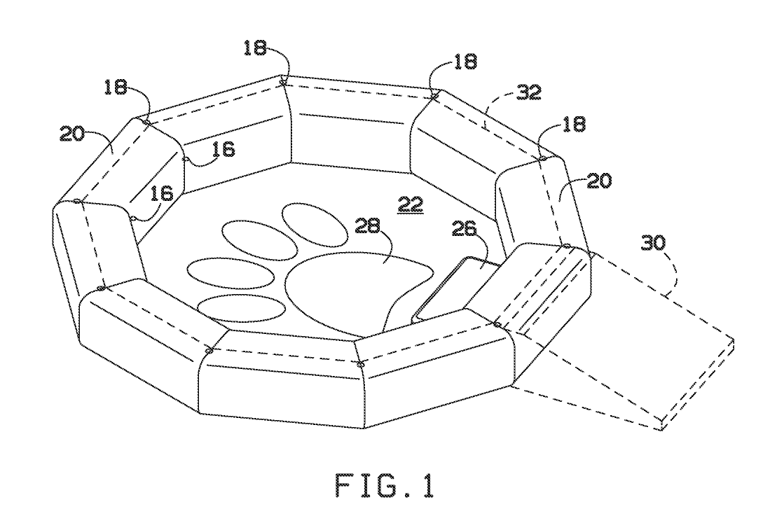

Referring now to FIGS. 1 through 3, a dog pool can be designed with a plurality of air chambers 20 interconnected to form side walls 24 of the dog pool. A floor 22 can be disposed on one side of the air chambers 20, interconnecting all of the air chambers 20 that form the side walls of the dog pool. The floor 22 and the side walls 24 can be made from a flexible, tear-resistant, air-impermeable material such as a heavy PVC tarpaulin material.

A step 26 can be disposed inside the dog pool, typically disposed along at least a portion of one of the air chambers 20. The step 26 can be a sand bag type of step that can be removably disposed inside the dog pool. In some embodiments, the step 26 can be an air bag interconnected to one of the air chambers 20 that make up the side wall 24. In this embodiment, the step 26 can be fixed to the side wall 24 and/or the floor 22. The step 26 can provide a height off the floor 22 so that a dog using the dog pool can rest on the step 26 without being submerged under the water. The step 26 can thus be used as a resting place for the dog, or as assistance for the dog to enter and exit the dog pool.

An optional ramp 30 can be disposed, outside of the dog pool, attached to the side wall 24 thereof. The ramp 30 can assist the dog in getting into and out of the dog pool.

A plurality of D-rings 18 can be disposed on the top of the air chambers 20 that form the side walls 24. The D-rings 18 can be used to secure an optional cover 32 over the dog pool. Two or more filtration D-rings 16 can be disposed on an inside of the air chambers 20. The filtration D-rings 16 can be used to secure a filter hose when an optional filtration system (not shown) is used to help clean and maintain the water in the dog pool.

An inflation nozzle 12 can be disposed on at least one of the air chambers 20. The inflation nozzle 12 can be used to inflate and deflate the air chambers 20 that form the dog pool (and the air chambers that optionally fill the step 26 and the ramp 30).

A warning label 14 can be placed on one of the air chambers 20 to provide instructions to the user as well as warnings and other suggestions for proper use of the dog pool.

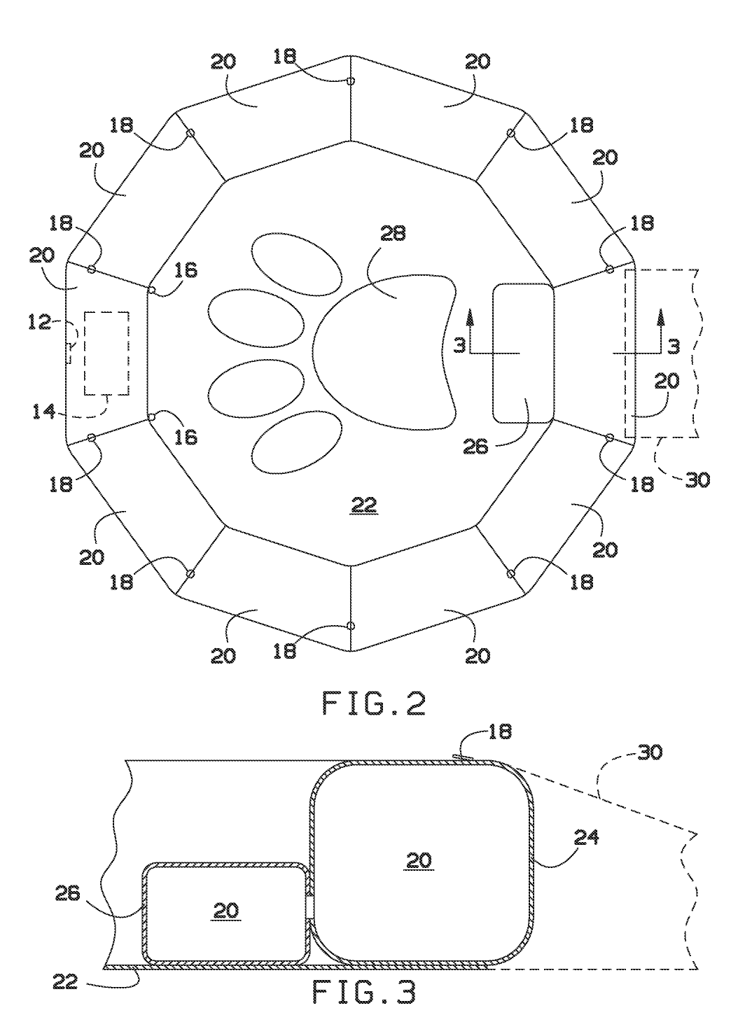

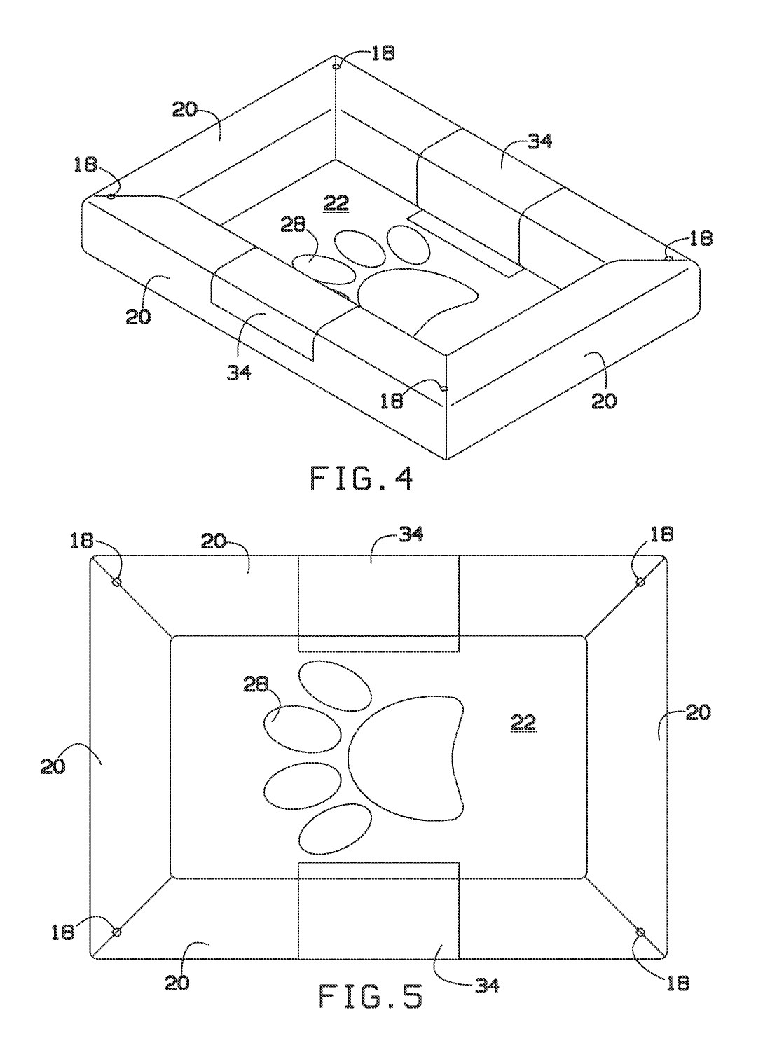

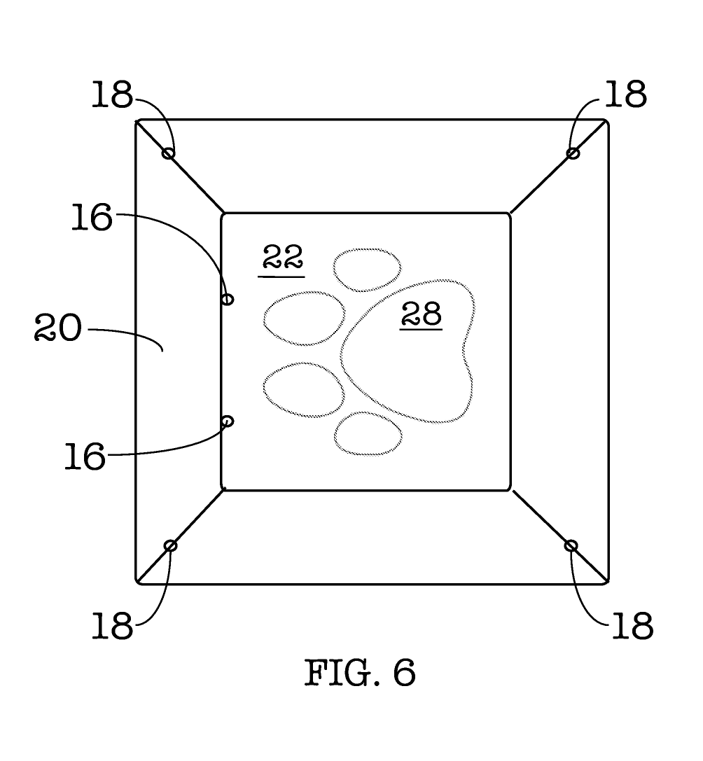

The dog pool can be made in a polygon shape, such as a decagon, as shown in FIGS. 1 and 2. In this embodiment, the sides of the polygon shape are typically short and may not need reinforcement. In some embodiments, as shown in FIGS. 4 and 5, the dog pool may be made in a rectangular or square shape, where long sides of the rectangular shape can be reinforced with a wall reinforcement 34. For example, the wall reinforcement 34 can be designed to sit over the side wall and extend into the pool and even may partially extend to the floor 22 of the dog pool. As shown in FIG. 6, the dog pool can also be made in a square shape.

The dog pool can include a symbol 28 in the middle of the pool. The symbol can be, for example, a dog paw, as shown in the Figures.

It should be understood, of course, that the foregoing relates to exemplary embodiments of the invention and that modifications may be made without departing from the spirit and scope of the invention as set forth in the following claims.

What is claimed is:

1. A dog pool comprising:
a plurality of interconnected air chambers forming side walls of the dog pool;
a floor disposed on one side of the plurality of interconnected air chambers and interconnecting the plurality of interconnected air chambers, such that the plurality of interconnected air chambers and the floor form a space to contain water; and
a step disposed along an inside of one of the plurality of interconnected air chambers forming the side walls.

2. The dog pool of claim 1, further comprising a plurality of rings attached to a top of the plurality of interconnected air chambers, the plurality of rings supporting a cover over the space.

3. The dog pool of claim 1, further comprising filtration rings disposed on an inside of the side walls, the filtration rings adapted to retain filtration nozzles.

4. The dog pool of claim 1, further comprising a ramp disposed from and attached to an outside portion of the side walls of the dog pool.

5. The dog pool of claim 1, wherein the plurality of interconnected air chambers form a polygon structure.

6. The dog pool of claim 5, wherein the polygon structure is a decagon.

7. The dog pool of claim 5, wherein the polygon structure is a rectangle or square.

8. The dog pool of claim 1, wherein the step is an air chamber interconnected with the plurality of air chambers forming the side walls.

9. The dog pool of claim 1, further comprising an inflation nozzle permitting inflation and deflation of the dog pool.

10. A dog pool comprising:
a plurality of interconnected air chambers forming side walls of the dog pool;
a floor disposed on one side of the plurality of interconnected air chambers and interconnecting the plurality of interconnected air chambers, such that the plurality of interconnected air chambers and the floor form a space to contain water;
a step disposed along an inside of one of the plurality of interconnected air chambers forming the side walls;
a plurality of rings attached to a top of the plurality of interconnected air chambers, the plurality of rings supporting a cover over the space;
filtration rings disposed on an inside of the side walls, the filtration rings adapted to retain filtration nozzles; and
an inflation nozzle permitting inflation and deflation of the dog pool.
